(19) United States
(12) Patent Application Publication
(10) Pub. No.: US 2020/0257982 A1
(43) Pub. Date: Aug. 13, 2020

(54) CATEGORICAL FEATURE ENCODING FOR PROPERTY GRAPHS BY VERTEX PROXIMITY

(71) Applicant: Oracle International Corporation, Redwood Shores, CA (US)

(72) Inventors: Jinha Kim, Sunnyvale, CA (US); Rhicheek Patra, Zurich (CH); Sungpack Hong, Palo Alto, CA (US); Damien Hilloulin, Zurich (CH); Davide Bartolini, Obersiggenthal (CH); Hassan Chafi, San Mateo, CA (US)

(21) Appl. No.: 16/270,535

(22) Filed: Feb. 7, 2019

(51) Int. Cl. G06N 3/08; G06N 3/04; G06N 5/04; G06N 20/10

(52) U.S. Cl. CPC G06N 3/084; G06N 20/10; G06N 5/046; G06N 3/0472

(57) ABSTRACT

Techniques are described herein for encoding categorical features of property graphs by vertex proximity. In an embodiment, an input graph is received. The input graph comprises a plurality of vertices, each vertex of said plurality of vertices is associated with vertex properties of said vertex. The vertex properties include at least one categorical feature value of one or more potential categorical feature values. For each of the one or more potential categorical feature values of each vertex, a numerical feature value is generated. The numerical feature value represents a proximity of the respective vertex to other vertices of the plurality of vertices that have a categorical feature value corresponding to the respective potential categorical feature value. Using the numerical feature values for each vertex, proximity encoding data is generated representing said input graph. The proximity encoding data is used to efficiently train machine learning models that produce results with enhanced accuracy.

### FIELD OF THE INVENTION

The present invention relates to graph processing and machine learning techniques based on encoded representations of graphs.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Feature extraction is a challenging problem in Machine Learning. When there are fine-grained correlations among data entities, it is difficult to capture those relationships and encode them into a low-dimensional feature space correctly. Trying to learn these relationships in brute-force manner through a complicated model (e.g. certain forms of deep neural network), is costly as it requires a lot of computation time and large data sets.

Categorical feature encoding is a task of transforming a categorical feature into an equivalent numerical feature. A categorical feature is an attribute of a data entity which has a fixed set of discrete values. An example of the categorical feature is continents ({America, Asia, Europe, Africa, Oceania}). In contrast, a numerical feature is an attribute of a data entity which has continuous range. An example of the numerical feature is a country's average temperature which is a decimal number.

Categorical feature encoding is required to apply machine learning models to data sets that include categorical features. For example, given a data set of several numerical and categorical features, one wants to learn a classification model using a support vector machine (SVM). As SVM only accepts numerical features, the categorical features must be converted into numerical features by applying the categorical feature encoding.

Many categorical feature encoding techniques have been proposed to deal with this feature type mismatch including ordinal encoding, one-hot encoding, and hashing encoding. Ordinal encoding assigns a random integer to each distinct categorical feature value. Binary encoding assigns a binary string instead of an integer. One-hot encoding creates one binary (0 or 1 numeric) feature for each category. However, these techniques simply encode categorical features into numbers and do not incorporate linked information between categorical features in graphs into the encoding.

Discussed herein are approaches for improving quality of graph-based machine learning results using enhanced categorical feature encoding techniques.

### BRIEF DESCRIPTION OF THE DRAWINGS

In the drawings:

FIG. 1 illustrates a property graph with categorical feature values for each vertex.

FIG. 2 illustrates a property graph with personalized page rank values for each vertex.

FIG. 3 shows an example procedure for encoding categorical features of property graphs by vertex proximity.

FIG. 4 is a diagram depicting a software system upon which an embodiment of the invention may be implemented.

FIG. 5 is a diagram depicting a computer system that may be used in an embodiment of the present invention.

### DETAILED DESCRIPTION

In the following description, for the purpose of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for encoding categorical features of property graphs by vertex proximity.

A property graph comprises a plurality of vertices. Each vertex of the plurality of vertices is associated with vertex properties of the respective vertex. A vertex property includes a categorical feature value of one or more potential categorical feature values. An example of a categorical feature is colors, with the potential categorical feature values of the colors category including: Red, Blue, and Green.

For each of the one or more potential categorical feature values of each vertex, a numerical feature value is generated. The numerical feature value represents a proximity of the respective vertex to other vertices of the plurality of vertices that have a categorical feature value corresponding to the respective potential categorical feature value. Generating the numerical feature value includes executing a proximity algorithm, such as a personalized page rank algorithm, using the respective vertex as the root vertex of the proximity algorithm.

Using the numerical feature values of each vertex, proximity encoding data is generated that represents the property graph. The proximity encoding data may include a suitable format for machine learning processing such as training or inference. The proximity encoding data captures an improved representation of the property graph by encoding the categorical features into numerical values that represent proximity information of the property graph.

Thus, techniques described herein extract features out of property-graph representations of data sets. These features can be used to train ML models, serving as very strong signals, and thereby resulting in significant improvement of the quality of the answer.

Compared to existing techniques, techniques described herein capture the original graphically represented information of data sets that include categorical features much better, thereby resulting in higher quality of the answers and drastically improving the classification accuracy of machine learning classification models. Techniques described herein result in dimensionality reduction, i.e. low dimensional representations for the vertices in the graph. The dimensionality of the features may be reduced, requiring smaller input vectors, and/or matrixes to store and process, thereby reducing storage and CPU processing needed for training machine learning models or executing machine learning models in applications of machine learning models. In addition, the machine learning models trained may have smaller model artifacts (see section MACHINE LEARNING MODELS), thereby further reducing storage and CPU processing needed for training machine learning models or executing machine learning models in applications of machine learning models.

### Graph Initialization

Graph analytics software such as Parallel Graph AnalytiX (PGX) may be used to initialize a property graph for vectorization. As referred to herein, PGX is a toolkit for graph analysis—both running algorithms such as PageRank against graphs, and performing SQL-like pattern-matching against graphs, using the results of algorithmic analysis. Algorithms are parallelized for extreme performance. The PGX toolkit includes both a single-node in-memory engine, and a distributed engine for extremely large graphs. Graphs can be loaded from a variety of sources including flat files, SQL and NoSQL databases and Apache Spark and Hadoop. PGX is commercially available through ORACLE CORPORATION. Additionally, techniques discussed herein are applicable to any graph analytic system that can compute a personalized page rank algorithm, as discussed herein.

In an embodiment, graph analytics software such as PGX loads a graph with an Edgelist file and Edge JSON file. The Edgelist file contains graph information in edge-list format regarding vertex objects and the edge objects to build the graphs.

The Edge JSON file is a JSON file that reads the graph data from the Edgelist file and generates a graph. In an embodiment, the Edge JSON file generates a PgxGraph, a java class of graphs that is operable by PGX. In an embodiment, a graph is loaded using PGX's ‘readGraphWithProperties’ functionality.

Graphs are generated based on original vertex properties and computed vertex properties. In the above-mentioned edge-list format, it is possible to pre-define multiple original vertex properties while loading the graph into a graph analytics framework such as PGX. For example, if there are multiple graphs comprising varying graph-ids, a vertex property can be added that indicates which graph the specific vertex belongs to. Then, the complete set of graphs can be loaded into PGX as a single large graph with multiple connected components and the individual connected components can be filtered out into separate graphs using such specific vertex property. Additionally, a unique vertex-id is assigned to all the vertices from different graphs in our dataset (i.e., no two graphs will have same vertex-ids).

Additional vertex properties may be defined, referred to herein as computed properties, depending on the requirement of the associated ML model that uses the graph data as input. For example, a ML model may require incorporating some “importance” values for the individual vertices while matching similar graphs. Such importance values may be added as computed properties to the vertices.

A vertex property may comprise a categorical feature or a numerical feature. A categorical feature is a vertex property that has a fixed set of discrete values. An example of a categorical feature is continents, with the potential values of the continents including: North America, South America, Asia, Europe, Africa, Antarctica, Australia. A numerical feature is a vertex property that has a continuous range. An example of a numerical feature is a country's average temperature which is represented as a decimal number.

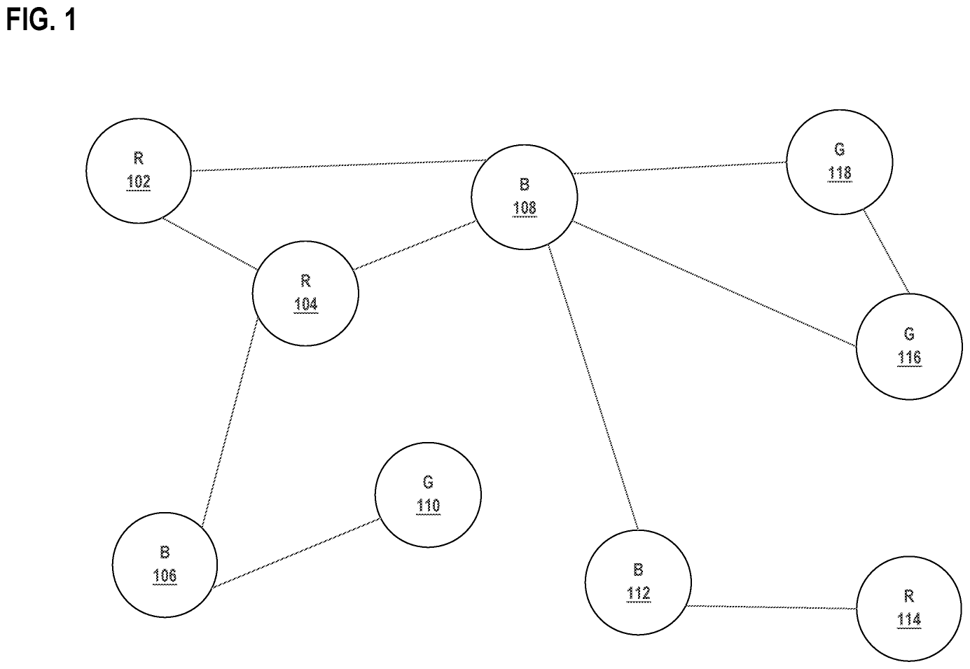

FIG. 1 illustrates a property graph with categorical feature values for each vertex. For example, in the graph of FIG. 1, each vertex includes a categorical feature ‘color’, where the potential categorical feature values of the categorical feature ‘color’ include red, green, and blue. Vertices 102, 104, 114 have a categorical feature value ‘R’, abbreviated for categorical feature value ‘red’. Vertices 110, 116, 118 have a categorical feature value ‘G’, abbreviated for categorical feature value ‘green’. Vertices 106, 108, 112 have a categorical feature value ‘B’, abbreviated for categorical feature value ‘blue’.

In an embodiment, the property graph is an undirected graph. An undirected graph is defined as a graph whose edges are unordered pairs of vertices. That is, each edge connects two vertices and each edge is bidirectional.

In an embodiment, the property graph is a directed graph. A directed graph is defined as a graph whose edges are ordered pairs of vertices. That is, each edge connects two vertices and each edge is unidirectional.

Once a property graph is initialized, graph analytics software such as PGX may be used to analyze and perform operations, such as personalized page rank, using the graph data. Techniques such as personalized page rank utilize techniques such as random walks and page rank. A brief description of random walks and page rank is therefore useful.

### Random Walks

Given a graph, a random walk is an iterative process that starts from a random vertex, and at each step, either follows a random outgoing edge of the current vertex or jumps to a random vertex. Some vertices may not have any outgoing edges so a walk will terminate at those places without jumping to another vertex.

### Page Rank

In general, Page Rank (PR) is an algorithm that measures the transitive influence or connectivity of nodes. PR measures stationary distribution of one specific kind of random walk that starts from a random vertex and in each iteration, with a predefined probability (p), jumps to a random vertex, and with probability (l-p), follows a random outgoing edge of the current vertex. Page rank is usually conducted on a graph with homogeneous edges, for example, a graph with edges in the form of “A linksTo B”, “A references B”, or “A likes B”, or “A endorses B”, or “A readsBlogsWrittenBy B”, or “A hasImpactOn B”. Running a page rank algorithm on a graph generates rankings for vertices and the numeric PR values can be viewed as “importance” or “relevance” of vertices. A vertex with a high PR value is usually considered more “important” or more “influential” or having higher “relevance” than a vertex with a low PR value.

### Personalized Page Rank

Personalized Page Rank (PPR) is similar to PR except that jumps are back to one of a given set of root vertices for which the PR is personalized for. The random walk in PPR is biased towards, or personalized for, the selected set of root vertices and is more localized compared to the random walk performed in PR.

Executing a PPR algorithm produces a measurement of proximity (distance metric), that is, how similar (relevant) a root vertex is to other vertices in a graph. In context of categorical features of a graph, PPR can be used to encode categorical features into numerical features that specify the proximity of a vertex in a graph from vertices in the graph that have a specific categorical value. In an embodiment, any suitable proximity algorithm can be used to generate numerical feature values that represent the proximity of a vertex in a graph from vertices in the graph that have a specific categorical value.

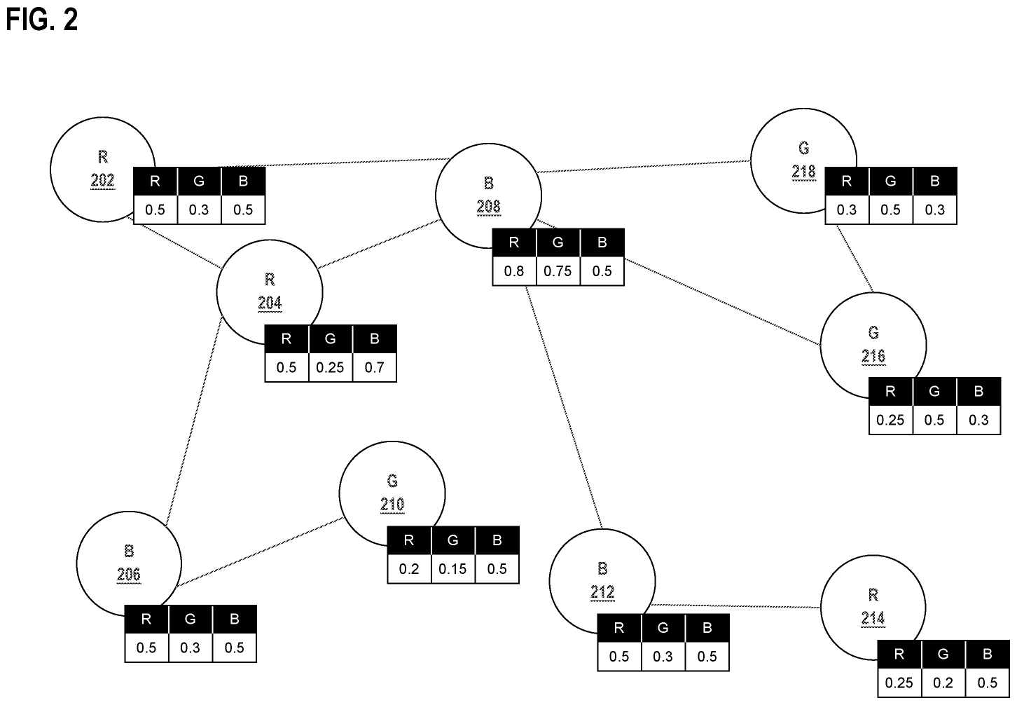

FIG. 2 illustrates a property graph with personalized page rank values for each vertex. For example, in the graph of FIG. 2, each vertex includes a categorical feature ‘color’, where the potential categorical feature values of the categorical feature ‘color’ include red, green, and blue. Vertices 202, 204, 214 have a categorical feature value ‘R’, abbreviated for categorical feature value ‘red’. Vertices 210, 216, 218 have a categorical feature value ‘G’, abbreviated for categorical feature value ‘green’. Vertices 206, 208, 212 have a categorical feature value ‘B’, abbreviated for categorical feature value ‘blue’.

Each vertex of FIG. 2 includes a set of personalized page rank values (PPR values). Each PPR value for a vertex is generated by executing a PPR algorithm for each potential categorical feature value using the vertex as the root vertex. Each PPR value comprises a numerical feature value and represents a vertex's proximity to other vertices that all have the same categorical feature value as the categorical feature value that the PPR value is generated for. PPR values may be stored as vertex properties for each respective vertex.

For example, by executing a PPR algorithm using vertex 202 as the root vertex, the PPR algorithm generates a ‘R’ PPR value of 0.5, a ‘G’ PPR value of 0.3, and a ‘B’ PPR value of 0.5. As discussed above, each PPR value represents the proximity of vertex 202 to other vertices that all have the same categorical feature value as the categorical feature value that the PPR value is generated for. Thus, the ‘R’ PPR value of vertex 202 represents the proximity of vertex 202 to vertices 204, 214, all of which have a categorical feature value of ‘R’. Similarly, the ‘G’ PPR value of vertex 202 represents the proximity of vertex 202 to vertices 216, 210, 218, all of which have a categorical feature value of ‘G’. Further, a ‘B’ PPR value of vertex 202 represents the proximity of vertex 202 to vertices 206, 208, 212, all of which have a categorical feature value of ‘B’.

Any available algorithms can be used to calculate a PPR for a vertex in a graph. For example, technical details and examples of PPR calculating algorithms are taught in the related reference “FAST-PPR: Scaling Personalized PageRank Estimation for Large Graphs” by Peter Lofgren, Siddhartha Banerjee, Ashish Goel, C. Seshadhri, August 2014. Additionally, a pseudocode example of calculating a PPR for a vertex is shown below:

```
′n′ <- # of vetices
′m′ <- # of root vertices
is_seed(′u′) = 1 if ′u′ is a root vertex, 0 otherwise
/* ininitilze */
for each vertex ′u′
do
  ppr(′u′) <- (1 / m) if is_seed(′u′) == true, 0 otherwiase
done
/* update */
until ′diff′ (sum of ppr value difference from the previous itermation) is
negligible
do
  for each vertex ′u′
    do
      ′prev_ppr′ = ppr(′u′)
      /* the below expression is used in the next page of [0040] */
        ppr(′u′) <- \alpha * is_seed(′u′) + (1 − \alpha) sum_
        {′v′\in nbr(′u′)} ppr(′v′) / degree(′u′)
      ′diff′ <- ′diff′ + (ppr(′u′) − ′prev_ppr′)
    done
done
```

In an embodiment, for vertices that have the same categorical feature value as the target categorical feature of the PPR, their PPR values are discounted. The PPR values are discounted or reduced because PPR values of such vertices may include the influence of themselves. Such influence should be excluded as the encoded feature is the proximity of each categorical feature to each vertex. For example, when generating the ‘R’ or ‘red’ PPR value for vertex 202, because vertex 202 has a ‘red’ categorical feature value, the PPR value for ‘R’ of vertex 202 should be discounted. A separate PPR computation is required to discount the PPR value. In this example, for vertex 202's ‘R’ PPR value, a PPR of vertex 202 from vertex 204 and vertex 214, i.e. vertices that have a ‘R’ categorical feature value except vertex 202 itself, should be calculated.

In another embodiment, to avoid additional PPR value computation, the PPR value is discounted by a damping factor. In PPR value computation, a damping factor is the probability that a random walk is reset. Formally, the PPR is defined as follows where alpha is the damping factor:

ppr(u) = \alpha * is_seed(u) + (1 − \alpha) sum_{v \in nbr(u)} ppr(v) /
degree(u)
is_seed(u) = 1 if u has the target category, 0 otherwise

Accordingly, the damping factor acts as the lower bound of the influence from a vertex itself. For example, in FIG. 2, the ‘R’ PPR values of vertices 202, 204, 214 that have a ‘R’ categorical feature value are discounted by the damping factor 0.25.

### Inferring Categorical Feature Values

For vertices that have a missing categorical feature, the missing categorical feature value can be inferred based on generated PPR values. For example, if a particular vertex has a missing categorical feature value in the category ‘color’, and the PPR values for ‘red’, ‘green’ and ‘blue’ are 0.5, 0.2, 0.1, respectively, it can be inferred that the categorical feature value for the particular vertex is ‘red’, since vertices having a ‘red’ value for the ‘color’ categorical feature are the closest in proximity, i.e. have the greatest PPR value, to the particular vertex compared to ‘green’ and ‘blue’ vertices.

### Example Procedure

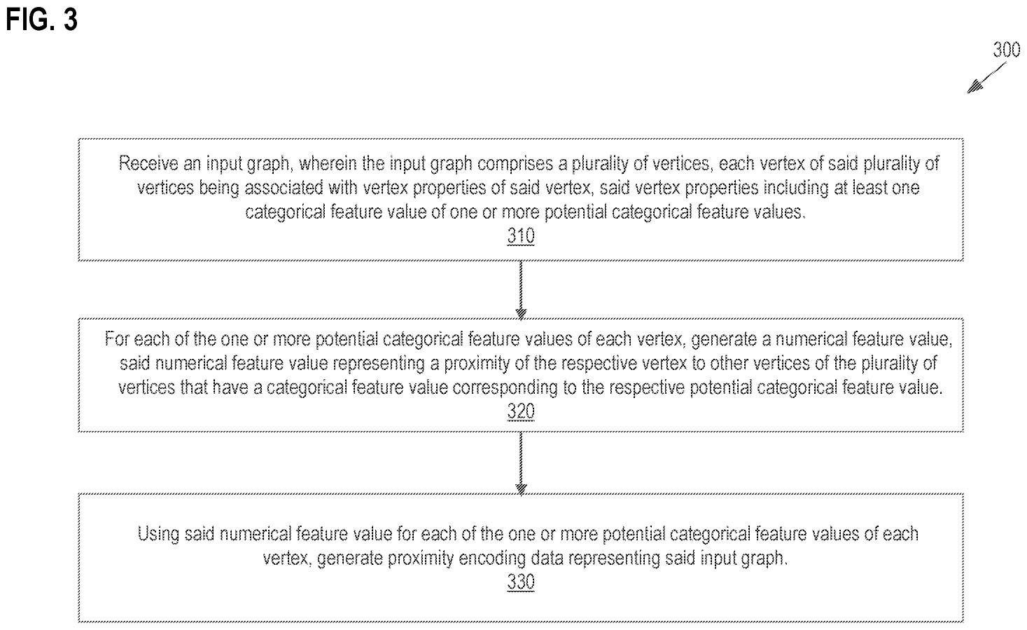

FIG. 3 shows an example procedure flow 300 for encoding categorical features of property graphs by vertex proximity. Flow 300 is one example of a flow for encoding categorical features of property graphs by vertex proximity. Other flows may comprise fewer or additional elements, in varying arrangements.

In step 310, an input graph is received. The input graph comprises a plurality of vertices, each vertex of said plurality of vertices is associated with vertex properties of said vertex. The vertex properties include at least one categorical feature value of one or more potential categorical feature values. For example, FIG. 1 illustrates an example input graph. Each vertex 102-118 includes a categorical feature value of one or more potential categorical feature values. Vertex 102, for example, includes the categorical feature value ‘R’ of the potential categorical feature values ‘R’, ‘G’, ‘B’ for the categorical feature ‘colors’.

In step 320, for each of the one or more potential categorical feature values of each vertex, a numerical feature value is generated. The numerical feature value represents a proximity of the respective vertex to other vertices of the plurality of vertices that have a categorical feature value corresponding to the respective potential categorical feature value. For example, FIG. 2 illustrates a graph with a numerical feature value for each of the one or more potential categorical feature values of each vertex. Each vertex 202-218 includes numerical feature values, such as ‘0.5, ‘0.3’, ‘0.5’ of vertex 202, for each potential categorical feature value ‘R’, ‘G’, ‘B’, respectively. In an embodiment, a numerical feature value comprises a PPR value, as discussed herein.

In step 330, using the numerical feature value for each of the one or more potential categorical feature values of each vertex, proximity encoding data is generated representing said input graph. The numerical feature values of each vertex are aggregated to form proximity encoding data the represents the entire input graph. The proximity encoding data may include a suitable format for machine learning processing such as training or inference.

In an embodiment, the proximity encoding data includes a numerical feature value for each respective categorical feature value of each vertex of the plurality of vertices.

In an embodiment, a machine learning algorithm is trained based on the proximity encoding data as input features and or output.

### Benefits for Improved Classification Accuracy

Feature synthesis is the process of transforming raw input into features that may be used as input to a machine learning model. Feature synthesis may also transform other features into input features. Feature engineering refers to the process of identifying features. A goal of feature engineering is to identify a feature set with higher feature predicative quality for a machine learning algorithm or model.

For feature synthesis and engineering in machine learning, it is difficult to capture fine-grained correlations among data entities and encode them into low dimensional feature space correctly. Learning these relationships in brute-force manner through complicated model (e.g. certain forms of deep neural network), is computationally costly as it requires a lot of computation time and large data sets.

Techniques discussed herein enable users to reduce computational costs of data preparation, training, validation by extracting categorical feature encoding from graph representations of data sets. These techniques provide a way to synthesize features by incorporating the linked information of a graph into features, resulting in with higher predicative quality which can be used to cause machine learning algorithms and models to yield more accurate predictions. The resulting feature sets with high predicative quality are smaller and require less memory and storage to store. Additionally, resulting feature sets with higher predicative quality also enable generation of machine learning models that have less complexity and smaller artifacts, thereby reducing training time and execution time when executing a machine learning model. Smaller artifacts also require less memory and/or storage to store.

For example, training models using linked graph information results in more accurate model predictions during inference compared to models that simply encode categorical features into numerical features without using linked graph information such as proximity metrics.

Additionally, techniques discussed herein provide enhanced feature engineering techniques such as providing a way to infer missing values for a categorical property based on the linked information of the graph. By inferring missing values, a former incomplete graph-based data set can be accurately completed to form a feature set with high predicative quality and then used to efficiently train and execute machine learning models, as discussed above. By accurately inferring values and completing a graph-based data set, machine learning models can be more accurately trained and thus produce more accurate predictions while requiring less memory and/or storage.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Software Overview

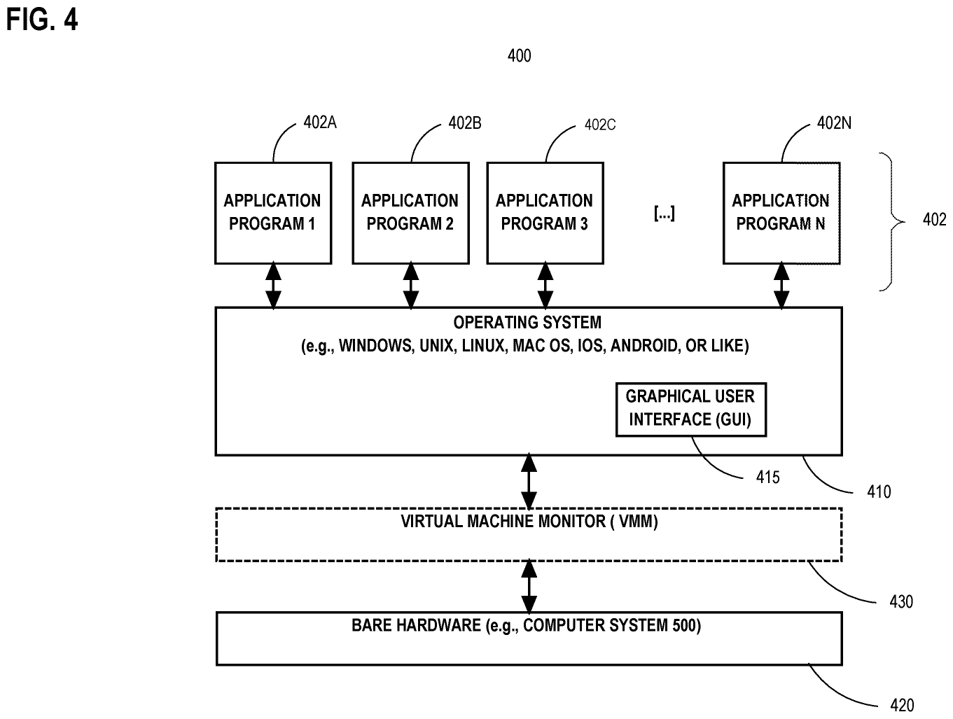

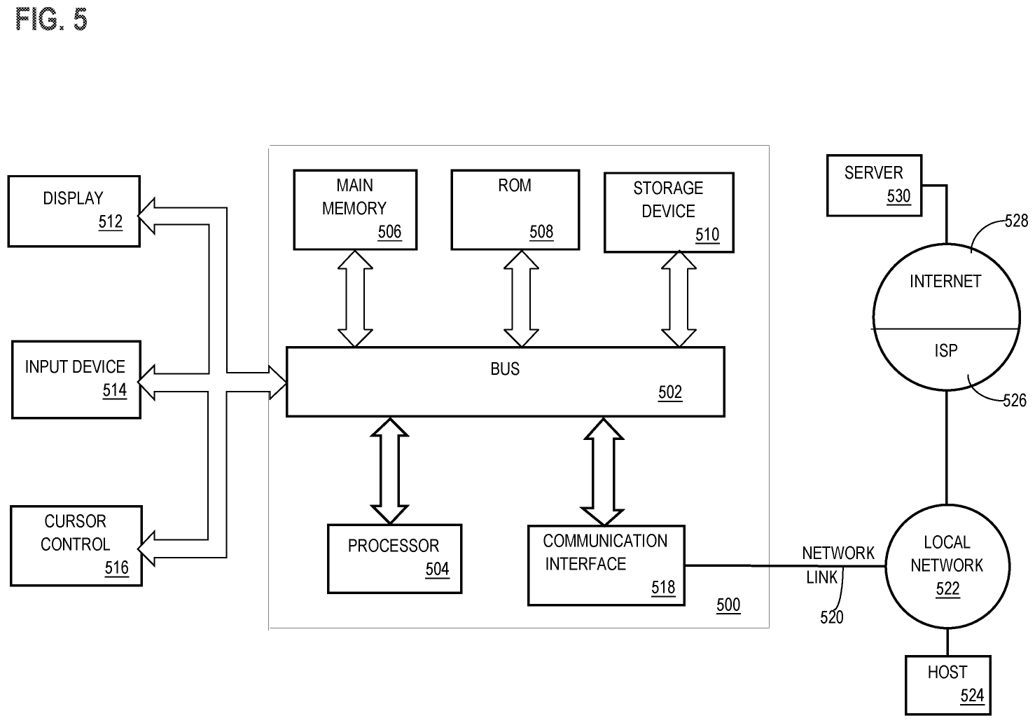

FIG. 4 is a block diagram of a basic software system 400 that may be employed for controlling the operation of computing system 500 of FIG. 5. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 600. Software system 400, which may be stored in system memory (RAM) 506 and on fixed storage (e.g., hard disk or flash memory) 510, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 510 into memory 506) for execution by the system 400. The applications or other software intended for use on computer system 500 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 504) of computer system 500. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 500.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 500 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

Multiple threads may run within a process. Each thread also comprises an allotment of hardware processing time but share access to the memory allotted to the process. The memory is used to store content of processors between the allotments when the thread is not running. The term thread may also be used to refer to a computer system process in multiple threads are not running.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programming languages including C #, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake a I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptrons (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Autoencoder implementation and integration techniques are taught in related U.S. patent application Ser. No. 14/558,700, entitled “AUTO-ENCODER ENHANCED SELF-DIAGNOSTIC COMPONENTS FOR MODEL MONITORING”. That patent application elevates a supervised or unsupervised ANN model as a first class object that is amenable to management techniques such as monitoring and governance during model development such as during training.

### Deep Context Overview

As described above, an ANN may be stateless such that timing of activation is more or less irrelevant to ANN behavior. For example, recognizing a particular letter may occur in isolation and without context. More complicated classifications may be more or less dependent upon additional contextual information. For example, the information content (i.e. complexity) of a momentary input may be less than the information content of the surrounding context. Thus, semantics may occur based on context, such as a temporal sequence across inputs or an extended pattern (e.g. compound geometry) within an input example. Various techniques have emerged that make deep learning be contextual. One general strategy is contextual encoding, which packs a stimulus input and its context (i.e. surrounding/related details) into a same (e.g. densely) encoded unit that may be applied to an ANN for analysis. One form of contextual encoding is graph embedding, which constructs and prunes (i.e. limits the extent of) a logical graph of (e.g. temporally or semantically) related events or records. The graph embedding may be used as a contextual encoding and input stimulus to an ANN.

Hidden state (i.e. memory) is a powerful ANN enhancement for (especially temporal) sequence processing. Sequencing may facilitate prediction and operational anomaly detection, which can be important techniques. A recurrent neural network (RNN) is a stateful MLP that is arranged in topological steps that may operate more or less as stages of a processing pipeline. In a folded/rolled embodiment, all of the steps have identical connection weights and may share a single one dimensional weight vector for all steps. In a recursive embodiment, there is only one step that recycles some of its output back into the one step to recursively achieve sequencing. In an unrolled/unfolded embodiment, each step may have distinct connection weights. For example, the weights of each step may occur in a respectvie column of a two dimensional weight matrix.

A sequence of inputs may be simultaneously or sequentially applied to respective steps of an RNN to cause analysis of the whole sequence. For each input in the sequence, the RNN predicts a next sequential input based on all previous inputs in the sequence. An RNN may predict or otherwise output almost all of the input sequence already received and also a next sequential input not yet received. Prediction of a next input by itself may be valuable. Comparison of a predicted sequence to an actually received (and applied) sequence may facilitate anomaly detection. For example, an RNN based spelling model may predict that a U follows a Q while reading a word letter by letter. If a letter actually following the Q is not a U as expected, then an anomaly is detected.

Unlike a neural layer that is composed of individual neurons, each recurrence step of an RNN may be an MLP that is composed of cells, with each cell containing a few specially arranged neurons. An RNN cell operates as a unit of memory. An RNN cell may be implemented by a long short term memory (LSTM) cell. The way LSTM arranges neurons is different from how transistors are arranged in a flip flop, but a same theme of a few control gates that are specially arranged to be stateful is a goal shared by LSTM and digital logic. For example, a neural memory cell may have an input gate, an output gate, and a forget (i.e. reset) gate. Unlike a binary circuit, the input and output gates may conduct an (e.g. unit normalized) numeric value that is retained by the cell, also as a numeric value.

An RNN has two major internal enhancements over other MLPs. The first is localized memory cells such as LSTM, which involves microscopic details. The other is cross activation of recurrence steps, which is macroscopic (i.e. gross topology). Each step receives two inputs and outputs two outputs. One input is external activation from an item in an input sequence. The other input is an output of the adjacent previous step that may embed details from some or all previous steps, which achieves sequential history (i.e. temporal context). The other output is a predicted next item in the sequence. Example mathematical formulae and techniques for RNNs and LSTM are taught in related U.S. patent application Ser. No. 15/347,501, entitled “MEMORY CELL UNIT AND RECURRENT NEURAL NETWORK INCLUDING MULTIPLE MEMORY CELL UNITS.”

Sophisticated analysis may be achieved by a so-called stack of MLPs. An example stack may sandwich an RNN between an upstream encoder ANN and a downstream decoder ANN, either or both of which may be an autoencoder. The stack may have fan-in and/or fan-out between MLPs. For example, an RNN may directly activate two downstream ANNs, such as an anomaly detector and an autodecoder. The autodecoder might be present only during model training for purposes such as visibility for monitoring training or in a feedback loop for unsupervised training. RNN model training may use backpropagation through time, which is a technique that may achieve higher accuracy for an RNN model than with ordinary backpropagation. Example mathematical formulae, pseudocode, and techniques for training RNN models using backpropagation through time are taught in related W.I.P.O. patent application No. PCT/US2017/033698, entitled “MEMORY-EFFICIENT BACKPROPAGATION THROUGH TIME”.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving an input graph, wherein the input graph comprises a plurality of vertices, each vertex of said plurality of vertices being associated with vertex properties of said vertex, said vertex properties including at least one categorical feature value of one or more potential categorical feature values;
for each of the one or more potential categorical feature values of each vertex, generating a numerical feature value, said numerical feature value representing a proximity of the respective vertex to other vertices of the plurality of vertices that have a categorical feature value corresponding to the respective potential categorical feature value;
using said numerical feature value for each of the one or more potential categorical feature values of each vertex, generating proximity encoding data representing said input graph.

2. The method of claim 1, further comprising:
in response to determining that a particular vertex of the plurality of vertices does not include a particular categorical feature value, inferring the particular categorical feature value based on the numerical feature values of the particular vertex.

3. The method of claim 2, wherein inferring the categorical feature value includes:
determining the greatest numerical feature value of the numerical feature values of the particular vertex.

4. The method of claim 1, wherein generating the numerical feature value comprises discounting the numerical feature value by a damping factor.

5. The method of claim 4, wherein the damping factor represents a probability that a random walk included in an execution of a PPR algorithm used to generate each numerical feature value is reset.

6. The method of claim 1, wherein the input graph comprises at least one of: an undirected graph or a directed graph.

7. The method of claim 1, wherein generating the numerical feature value comprises executing a proximity algorithm for the respective vertex.

8. The method of claim 7, wherein the proximity algorithm comprises a personalized page rank (PPR) algorithm.

9. The method of claim 1, further comprising: training a machine learning model based on the proximity encoding data.

10. The method of claim 9, wherein the machine learning model comprises a classification model.

11. One or more non-transitory computer-readable media storing instructions which, when executed by one or more processors, cause:
receiving an input graph, wherein the input graph comprises a plurality of vertices, each vertex of said plurality of vertices being associated with vertex properties of said vertex, said vertex properties including at least one categorical feature value of one or more potential categorical feature values;
for each of the one or more potential categorical feature values of each vertex, generating a numerical feature value, said numerical feature value representing a proximity of the respective vertex to other vertices of the plurality of vertices that have a categorical feature value corresponding to the respective potential categorical feature value;
using said numerical feature value for each of the one or more potential categorical feature values of each vertex, generating proximity encoding data representing said input graph.

12. The one or more non-transitory computer-readable media of claim 11, further comprising instructions which, when executed by the one or more processors, cause:
in response to determining that a particular vertex of the plurality of vertices does not include a particular categorical feature value, inferring the particular categorical feature value based on the numerical feature values of the particular vertex.

13. The one or more non-transitory computer-readable media of claim 12, wherein inferring the categorical feature value includes:
determining the greatest numerical feature value of the numerical feature values of the particular vertex.

14. The one or more non-transitory computer-readable media of claim 11, wherein generating the numerical feature value comprises discounting the numerical feature value by a damping factor.

15. The one or more non-transitory computer-readable media of claim 14, wherein the damping factor represents a probability that a random walk included in an execution of a PPR algorithm used to generate each numerical feature value is reset.

16. The one or more non-transitory computer-readable media of claim 11, wherein the input graph comprises at least one of: an undirected graph or a directed graph.

17. The one or more non-transitory computer-readable media of claim 11, wherein generating the numerical feature value comprises executing a proximity algorithm for the respective vertex.

18. The one or more non-transitory computer-readable media of claim 17, wherein the proximity algorithm comprises a personalized page rank (PPR) algorithm.

19. The one or more non-transitory computer-readable media of claim 11, further comprising instructions which, when executed by the one or more processors, cause: training a machine learning model based on the proximity encoding data.

20. The one or more non-transitory computer-readable media of claim 19, wherein the machine learning model comprises a classification model.
